(19) United States
(12) Patent Application Publication
(10) Pub. No.: US 2014/0240227 A1
(43) Pub. Date: Aug. 28, 2014

(54) SYSTEM AND METHOD FOR CALIBRATING A TRACKING OBJECT IN A VISION SYSTEM

(71) Applicant: Corel Corporation, Ottawa (CA)

(72) Inventors: Christopher J. Tremblay, Cantley (CA); Stephen P. Bolt, Stittsville (CA)

(73) Assignee: Corel Corporation, Ottawa (CA)

(21) Appl. No.: 14/190,970

(22) Filed: Feb. 26, 2014

Related U.S. Application Data
(60) Provisional application No. 61/769,576, filed on Feb. 26, 2013.

(51) Int. Cl. G06F 3/00

(52) U.S. Cl. CPC G06F 3/005
USPC 345/156

(57) ABSTRACT

A method for calibrating a tracking object for use in a graphics application program executing on a computer is disclosed. The method includes a step of connecting a vision system to the computer, wherein the vision system is adapted to monitor a visual space. The method further includes a step of detecting, by the vision system, a tracking object in the visual space. The tracking object has an arcuate motion when guided by a user. The method further includes a step of executing, by the computer, a graphics application program, and outputting, by the vision system to the computer, spatial coordinate data representative of the location of the tracking object within the visual space. The method further includes a step of calibrating the tracking object to compensate for the arcuate motion.

### CROSS REFERENCE TO RELATED APPLICATION

Reference is made to and this application claims priority from and the benefit of U.S. Provisional Application Ser. No. 61/769,576, filed Feb. 26, 2013, entitled “SYSTEM AND METHOD FOR CALIBRATING A TRACKING OBJECT IN A VISION SYSTEM”, which application is incorporated herein in its entirety by reference.

### FIELD OF THE INVENTION

This disclosure relates generally to graphic computer software systems and, more specifically, to a system and method for creating computer graphics and artwork with a vision system.

### BACKGROUND OF THE INVENTION

Graphic software applications provide users with tools for creating drawings for presentation on a display such as a computer monitor or tablet. One such class of applications includes painting software, in which computer-generated images simulate the look of handmade drawings or paintings. Graphic software applications such as painting software can provide users with a variety of drawing tools, such as brush libraries, chalk, ink, and pencils, to name a few. In addition, the graphic software application can provide a ‘virtual canvas’ on which to apply the drawing or painting. The virtual canvas can include a variety of simulated textures.

To create or modify a drawing, the user selects an available input device and opens a drawing file within the graphic software application. Traditional input devices include a mouse, keyboard, or pressure-sensitive tablet. The user can select and apply a wide variety of media to the drawing, such as selecting a brush from a brush library and applying colors from a color panel, or from a palette mixed by the user. Media can also be modified using an optional gradient, pattern, or clone. The user then creates the graphic using a ‘start stroke’ command and a ‘finish stroke’ command. In one example, contact between a stylus and a pressure-sensitive tablet display starts the brushstroke, and lifting the stylus off the tablet display finishes the brushstroke. The resulting rendering of any brushstroke depends on, for example, the selected brush category (or drawing tool); the brush variant selected within the brush category; the selected brush controls, such as brush size, opacity, and the amount of color penetrating the paper texture; the paper texture; the selected color, gradient, or pattern; and the selected brush method.

As the popularity of graphic software applications flourish, new groups of drawing tools, palettes, media, and styles are introduced with every software release. As the choices available to the user increase, so does the complexity of the user interface menu. Graphical user interfaces (GUIs) have evolved to assist the user in the complicated selection processes. However, with the ever-increasing number of choices available, even navigating the GUIs has become time-consuming, and may require a significant learning curve to master. In addition, the GUIs can occupy a significant portion of the display screen, thereby decreasing the size of the virtual canvas.

### SUMMARY OF THE INVENTION

In accordance with one aspect of the disclosure, a method for calibrating a tracking object for use in a graphics application program executing on a computer includes a step of connecting a vision system to a computer, wherein the vision system is adapted to monitor a visual space. The method further includes a step of detecting, by the vision system, a tracking object in the visual space. The tracking object has an arcuate motion when guided by a user. The method further includes a step of executing, by the computer, a graphics application program, and outputting, by the vision system to the computer, spatial coordinate data representative of the location of the tracking object within the visual space. The method further includes a step of mapping a horizontal portion and a vertical portion of the spatial coordinate data to a display connected to the computer, and calibrating the tracking object to compensate for the arcuate motion.

In another aspect of the disclosure, a graphic computer software system includes a computer having one or more processors, one or more computer-readable memories, one or more computer-readable tangible storage devices, and program instructions stored on at least one of the one or more storage devices for execution by at least one of the one or more processors via at least one of the one or more memories. The graphic computer software system further includes a display connected to the computer, a tracking object having an arcuate motion when guided by a user, and a vision system connected to the computer, the vision system comprising one or more image sensors adapted to capture the location of the tracking object within a visual space. The vision system is adapted to output to the computer spatial coordinate data representative of the location of the tracking object within the visual space. The computer program instructions include program instructions to execute a graphics application program and output to the display, and program instructions to calibrate the tracking object to compensate for the arcuate motion.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a functional block diagram of a graphic computer software system according to one embodiment of the present invention;

FIG. 2 depicts a perspective schematic view of the graphic computer software system of FIG. 1;

FIG. 3 depicts a perspective schematic view of the graphic computer software system shown in FIG. 1 according to another embodiment of the present invention;

FIG. 4 depicts a perspective schematic view of the graphic computer software system shown in FIG. 1 according to yet another embodiment of the present invention;

FIG. 5 depicts a schematic front plan view of the graphic computer software system shown in FIG. 1;

FIG. 6 depicts another schematic front plan view of the graphic computer software system shown in FIG. 1;

FIG. 7 depicts a schematic top view of the graphic computer software system shown in FIG. 1;

FIG. 8 depicts an enlarged view of the graphic computer software system shown in FIG. 7;

FIG. 9 depicts a perspective schematic view of the graphic computer software system shown in FIG. 1 according to another embodiment of the present invention; and

FIG. 10 depicts a top plan view of the graphic computer software system shown in FIG. 9.

### DETAILED DESCRIPTION OF THE INVENTION

According to various embodiments of the present invention, a graphic computer software system provides a solution to the problems noted above. The graphic computer software system includes a vision system as an input device to track the motion of an object in the vision system's field of view. The output of the vision system is translated to a format compatible with the input to a graphics application program. The object's motion can be used to create brushstrokes, control drawing tools and attributes, and control a palette, for example. As a result, the user experience is more natural and intuitive, and does not require a long learning curve to master.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Program code embodied on a computer-readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as PHP, Javascript, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

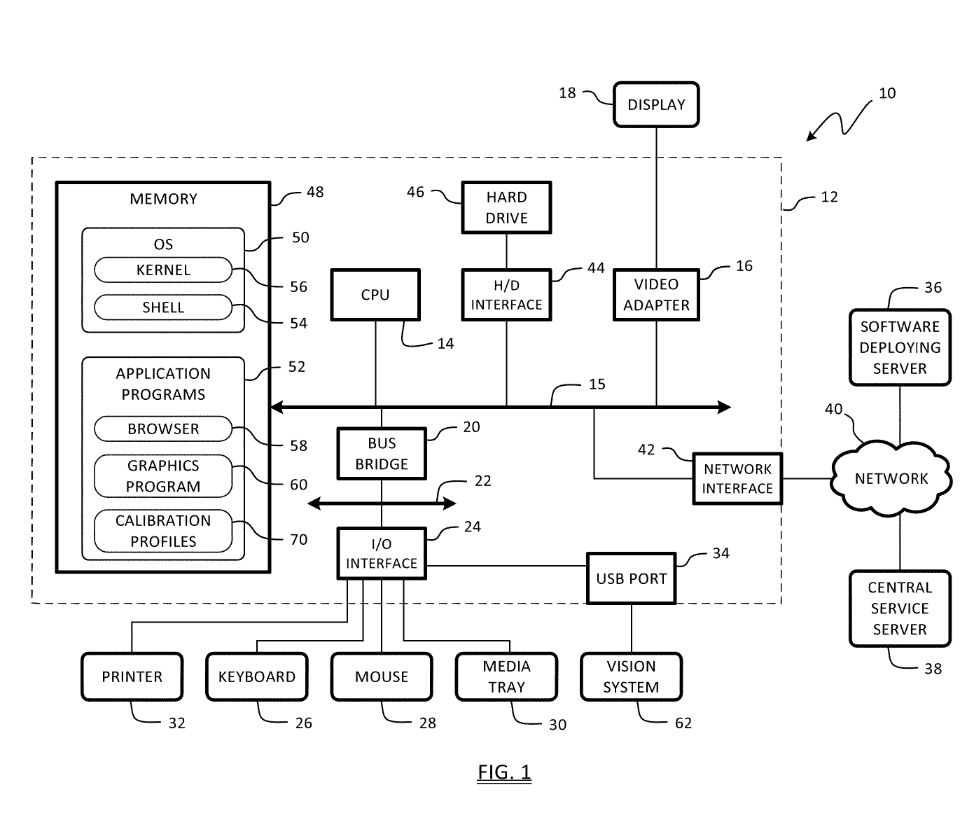

With reference now to the figures, and in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a block diagram of a graphic computer software system 10 according to one embodiment of the present invention. The graphic computer software system 10 includes a computer 12 having a computer readable storage medium which may be utilized by the present disclosure. The computer is suitable for storing and/or executing computer code that implements various aspects of the present invention. Note that some or all of the exemplary architecture, including both depicted hardware and software, shown for and within computer 12 may be utilized by a software deploying server and/or a central service server.

Computer 12 includes a processor (or CPU) 14 that is coupled to a system bus 15. Processor 14 may utilize one or more processors, each of which has one or more processor cores. A video adapter 16, which drives/supports a display 18, is also coupled to system bus 15. System bus 15 is coupled via a bus bridge 20 to an input/output (I/O) bus 22. An I/O interface 24 is coupled to (I/O) bus 22. I/O interface 24 affords communication with various I/O devices, including a keyboard 26, a mouse 28, a media tray 30 (which may include storage devices such as CD-ROM drives, multi-media interfaces, etc.), a printer 32, and external USB port(s) 34. While the format of the ports connected to I/O interface 24 may be any known to those skilled in the art of computer architecture, in a preferred embodiment some or all of these ports are universal serial bus (USB) ports.

As depicted, computer 12 is able to communicate with a software deploying server 36 and central service server 38 via network 40 using a network interface 42. Network 40 may be an external network such as the Internet, or an internal network such as an Ethernet or a virtual private network (VPN).

A storage media interface 44 is also coupled to system bus 15. The storage media interface 44 interfaces with a computer readable storage media 46, such as a hard drive. In a preferred embodiment, storage media 46 populates a computer readable memory 48, which is also coupled to system bus 14. Memory 48 is defined as a lowest level of volatile memory in computer 12. This volatile memory includes additional higher levels of volatile memory (not shown), including, but not limited to, cache memory, registers and buffers. Data that populates memory 48 includes computer 12's operating system (OS) 50 and application programs 52.

Operating system 50 includes a shell 54, for providing transparent user access to resources such as application programs 52. Generally, shell 54 is a program that provides an interpreter and an interface between the user and the operating system. More specifically, shell 54 executes commands that are entered into a command line user interface or from a file. Thus, shell 54, also called a command processor, is generally the highest level of the operating system software hierarchy and serves as a command interpreter. The shell 54 provides a system prompt, interprets commands entered by keyboard, mouse, or other user input media, and sends the interpreted command(s) to the appropriate lower levels of the operating system (e.g., a kernel 56) for processing. Note that while shell 54 is a text-based, line-oriented user interface, the present disclosure will equally well support other user interface modes, such as graphical, voice, gestural, etc.

As depicted, operating system (OS) 50 also includes kernel 56, which includes lower levels of functionality for OS 50, including providing essential services required by other parts of OS 50 and application programs 52, including memory management, process and task management, disk management, and mouse and keyboard management.

Application programs 52 include a renderer, shown in exemplary manner as a browser 58. Browser 58 includes program modules and instructions enabling a world wide web (WWW) client (i.e., computer 12) to send and receive network messages to the Internet using hypertext transfer protocol (HTTP) messaging, thus enabling communication with software deploying server 36 and other described computer systems.

The hardware elements depicted in computer 12 are not intended to be exhaustive, but rather are representative to highlight components useful by the present disclosure. For instance, computer 12 may include alternate memory storage devices such as magnetic cassettes (tape), magnetic disks (floppies), optical disks (CD-ROM and DVD-ROM), and the like. These and other variations are intended to be within the spirit and scope of the present disclosure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment of the invention, application programs 52 in computer 12's memory (as well as software deploying server 36's system memory) may include a graphics application program 60, such as a digital art program that simulates the appearance and behavior of traditional media associated with drawing, painting, and printmaking.

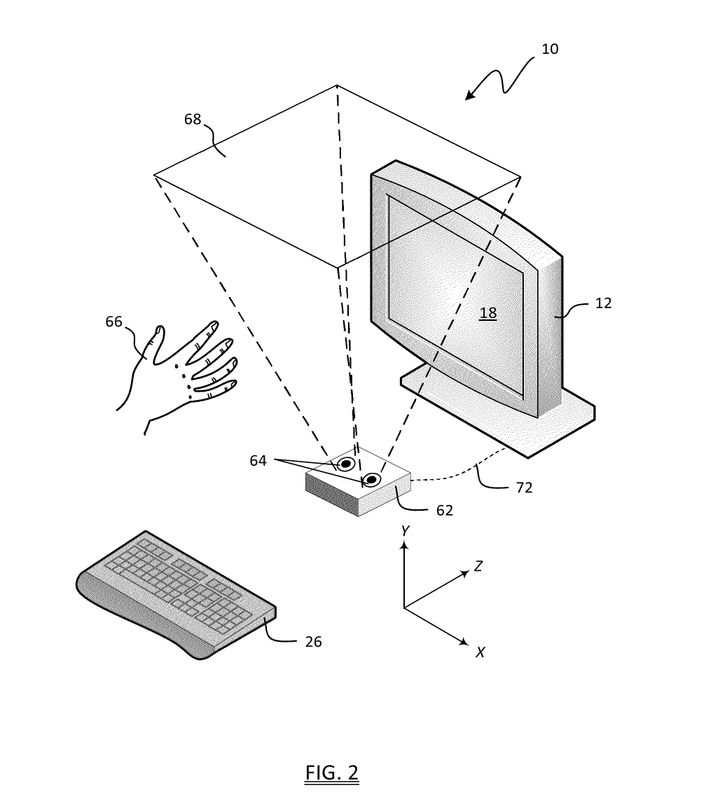

Turning now to FIG. 2, the graphic computer software system 10 further includes a computer vision system 62 as a motion-sensing input device to computer 12. The vision system 62 may be connected to the computer 12 wirelessly via network interface 42 or wired through the USB port 34, for example. In the illustrated embodiment, the vision system 62 includes stereo image sensors 64 to detect a tracking object 66 in a visual space 68 of the vision system, and capture its position and motion in the visual space. In one example, the vision system 62 is a Leap Motion controller available from Leap Motion, Inc. of San Francisco, Calif.

The visual space 68 is a three-dimensional area in the field of view of the image sensors 64. In one embodiment, the visual space 68 is limited to a small area to provide more accurate tracking and prevent noise (e.g., other objects) from being detected by the system. In one example, the visual space 68 is approximately 0.23 m³ (8 cu. ft.), or roughly equivalent to a 61 cm cube. As shown, the vision system 62 is positioned directly in front of the computer display 18, the image sensors 64 pointing vertically upwards. In this manner, a user may position themselves in front of the display 18 and draw or paint as if the display were a canvas on an easel.

In other embodiments of the present invention, the vision system 62 could be positioned on its side such that the image sensors 64 point horizontally. In this configuration, the vision system 62 can detect a tracking object 66 such as a hand, and the hand could be manipulating the mouse 28 or other input device. The vision system 62 could detect and track movements related to operation of the mouse 28, such as movement in an X-Y plane, right-click, left-click, etc. It should be noted that a mouse need not be physically present—the user's hand could simulate the movement of a mouse (or other input device such as the keyboard 26), and the vision system 62 could track the movements accordingly.

The tracking object 66 may be any object that can be detected, calibrated, and tracked by the vision system 62. In the example wherein the vision system is a Leap Motion controller, exemplary tracking objects 66 include one hand, two hands, one or more fingers, a stylus, painting tools, or a combination of any of those listed. Exemplary painting tools can include brushes, sponges, chalk, and the like.

The vision system 62 may include as part of its operating software a calibration routine 70 in order that the vision system recognizes each tracking object 66. For example, the vision system 62 may install program instructions including a detection process in the application programs 52 portion of memory 48. The detection process can be adapted to learn and store profiles 70 (FIG. 1) for a variety of tracking objects 66. The profiles 70 for each tracking object 66 may be part of the graphics application program 60, or may reside independently in another area of memory 48.

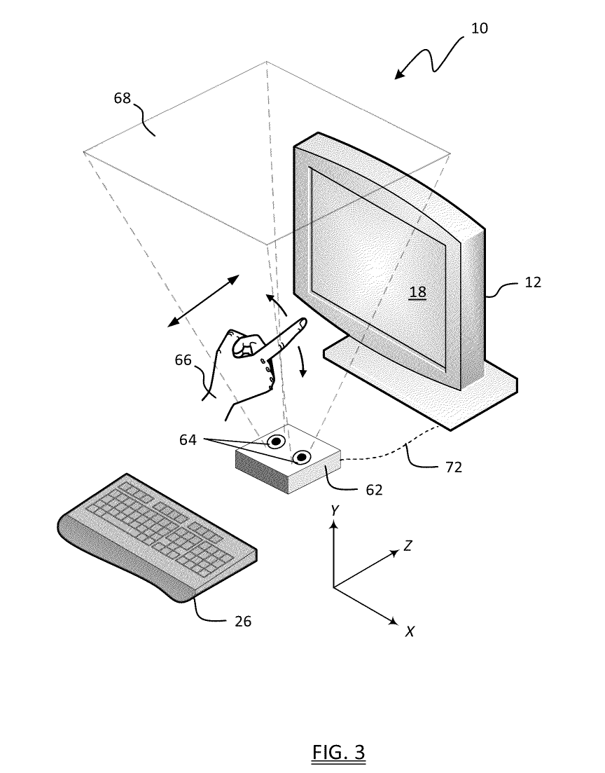

As shown in FIG. 3, insertion of a tracking object 66 such as a finger into the visual space 68 causes the vision system 62 to detect and identify the tracking object, and provide a data stream or spatial coordinate data 72 to computer 12 representative of the location of the tracking object 66 within the visual space 68. The particular spatial coordinate data 72 will depend on the type of vision system being used. In one embodiment, the spatial coordinate data 72 is in the form of three-dimensional coordinate data and a directional vector. In one example, the three-dimensional coordinate data may be expressed in Cartesian coordinates, each point on the tracking object being represented by (x, y, z) coordinates within the visual space 68. For purposes of illustration and to further explain orientation of certain features of the invention, the x-axis runs horizontally in a left-to-right direction of the user; the y-axis runs vertically in an up-down direction to the user; and the z-axis runs in a depth-wise direction towards and away from the user. In addition to streaming the current (x, y, z) position for each calibrated point or points on the tracking object 66, the vision system 62 can further provide a directional vector D indicating the instantaneous direction of the point, the length and width (e.g., size) of the tracking object, and the shape and geometry of the tracking object.

Traditional graphics application programs utilize a mouse or pressure-sensitive tablet as an input device to indicate position on the virtual canvas, and where to begin and end brushstrokes. In the case of a mouse as an input device, the movement of the mouse on a flat surface will generate planar coordinates that are fed to the graphics engine of the software application, and the planar coordinates are translated to the computer display or virtual canvas. Brushstrokes can be created by positioning the mouse cursor to a desired location on the virtual canvas and using mouse clicks to indicate start brushstroke and stop brushstroke commands. In the case of a tablet as an input device, the movement of a stylus on the flat plane of the tablet display will generate similar planar coordinates. In some tablets, application of pressure on the flat display can be used to indicate a start brushstroke command, and lifting the stylus can indicate a stop brushstroke command. In either case, the usefulness of the input device is limited to generating planar coordinates and simple binary commands such as start and stop.

In contrast, the spatial coordinate data 72 of the vision system 62 can be adapted to provide coordinate input to the graphics application program 60 in three dimensions, as opposed to only two. The three dimensional data stream, the directional vector information, and additional information such as the width, length, size, shape and geometry of the tracking object can be used to enhance the capabilities of the graphics application program 60 to provide a more natural user experience.

In one embodiment of the present invention, the (x, y) portion of the position data from the spatial coordinate data 72 can be mapped to (x′, y′) input data for a painting application program 60. As the user moves the tracking object 66 within the visual space 68, the (x, y) coordinates are mapped and fed to the graphics engine of the software application, then ‘drawn’ on the virtual canvas. The mapping step involves a conversion from the particular coordinate output format of the vision system to a coordinate input format for the painting application program 60. In one embodiment using the Leap Motion controller, the mapping involves a two-dimensional coordinate transformation to scale the (x, y) coordinates of the visual space 68 to the (x′, y′) plane of the virtual canvas.

The (z) portion of the position data from the spatial coordinate data 72 can be captured to utilize specific features of the graphics application program 60. In this manner, the (x, y) coordinates could be utilized for a position database and the (z) coordinates could be utilized for another, separate database. In one example, depth coordinate data can provide start brushstroke and stop brushstroke commands as the tracking object 66 moves through the depth of visual space 68. The tracking object 66 may be a finger or a paint brush, and the graphics application program 60 may be a digital paint studio. The user may prepare to apply brush strokes to the virtual canvas by inserting the finger or brush into the visual space 68, at which time coordinate output data 72 begins streaming to the computer 12 for mapping, and the tracking object appears on the display 18. The brushstroke start and stop commands may be initiated via keyboard 26 or by holding down the left-click button of the mouse 28. In one embodiment of the invention, the user moves the tracking object 66 in the z-axis to a predetermined point, at which time the start brushstroke command is initiated. When the user pulls the tracking object 66 back in the z-axis past the predetermined point, the stop brushstroke command is initiated and the tracking object “lifts” off the virtual canvas.

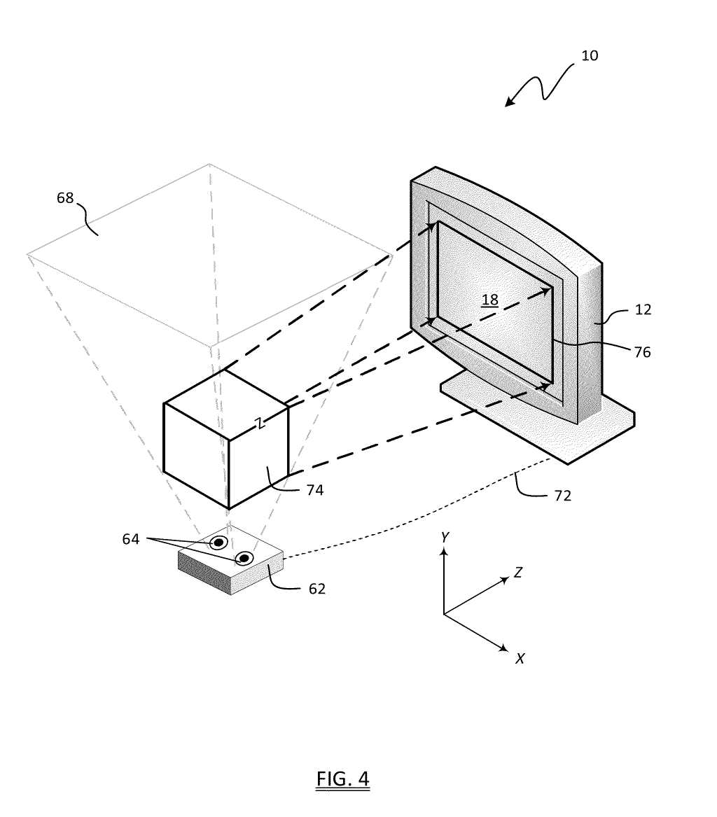

In another embodiment of the invention, a portion of the visual space can be calibrated to enhance the operability with a particular graphics application program. Turning to FIG. 4, the vision system mapping function can include defining a calibrated visual space 74 to provide a virtual surface 76 on the display 18. The virtual surface 76 correlates to the virtual canvas on the painting application program 60. The virtual surface 76 can be represented by the entire screen, a virtual document, a document with a boundary zone, or a specific window, for example. The calibrated visual space 74 can be established by default settings (e.g., ‘out of the box’), by specific values input and controlled by the user, or through a calibration process. In one example, a user can conduct a calibration by indicating the eight corners of the desired calibrated visual space 74. The corners can be indicated by a mouse click, or by a defined gesture with the tracking object 66, for example.

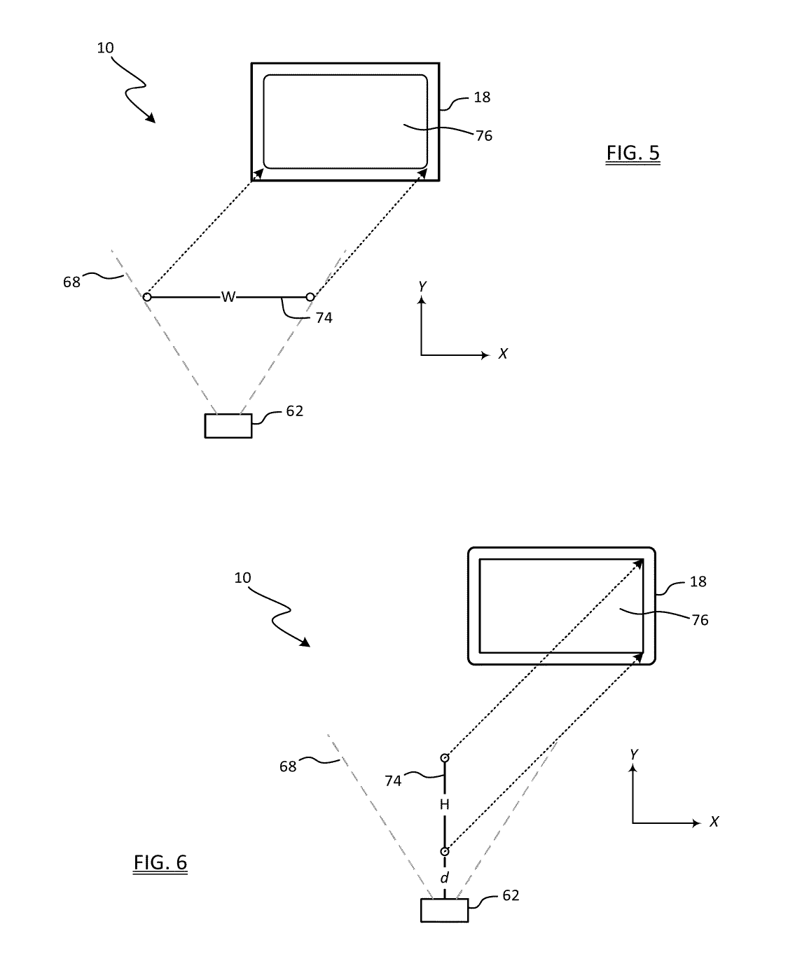

FIG. 5 depicts a schematic front plan view of a calibrated horizontal position 74 in the visual space 68 mapped to the horizontal position in the virtual surface 76. The mapping system may allow control of how much displacement (W) is needed to reach the full virtual surface extents, horizontally. In a typical embodiment, a horizontal displacement (W) of approximately 30 cm (11.8 in.) with a tracking object in the visual space 68 will be sufficient to extend across the entire virtual surface 76. However, the user can select a smaller amount of horizontal displacement if they wish, for example 10 cm (3.9 in.). The center position can also be offset within the visual space, left or right, if desired.

FIG. 6 depicts a schematic front plan view of a calibrated vertical position 74 in the visual space 68 mapped to the vertical position in the virtual surface 76. The mapping system may allow control of how much displacement (H) is needed to reach the full virtual surface extents, vertically. In a typical embodiment, a vertical displacement (H) of approximately 30 cm (11.8 in.) with a tracking object in the visual space 68 will be sufficient to extend across the entire virtual surface 76. The calibrated position 74 may further include a vertical offset (d) from the vision system 62 below which input objects will be ignored. The offset can be defined to give a user a comfortable, arm's length position when drawing.

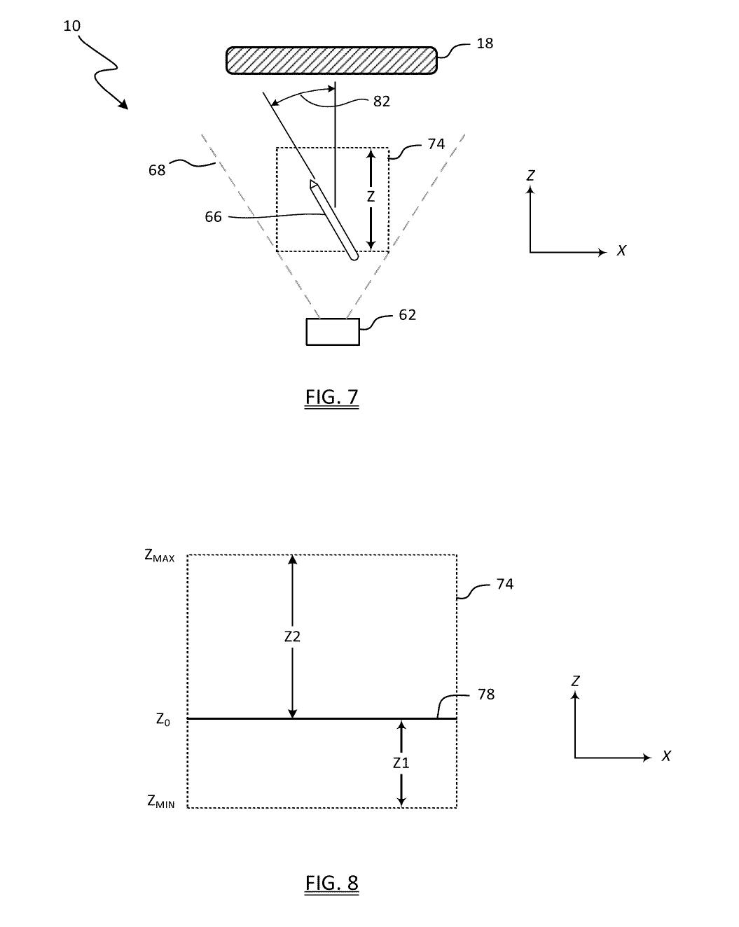

FIG. 7 depicts a schematic top view of a calibrated depth position 74 in the visual space 68. The calibrated depth position 74 can be calibrated by any of the methods described above with respect to the height (H) and width (W). The depth (Z) of the tracking object 66 in the visual space 68 is not required to map the object in the X-Y plane of the virtual surface 76, and the (z) coordinate data 72 can be useful for a variety of other functions.

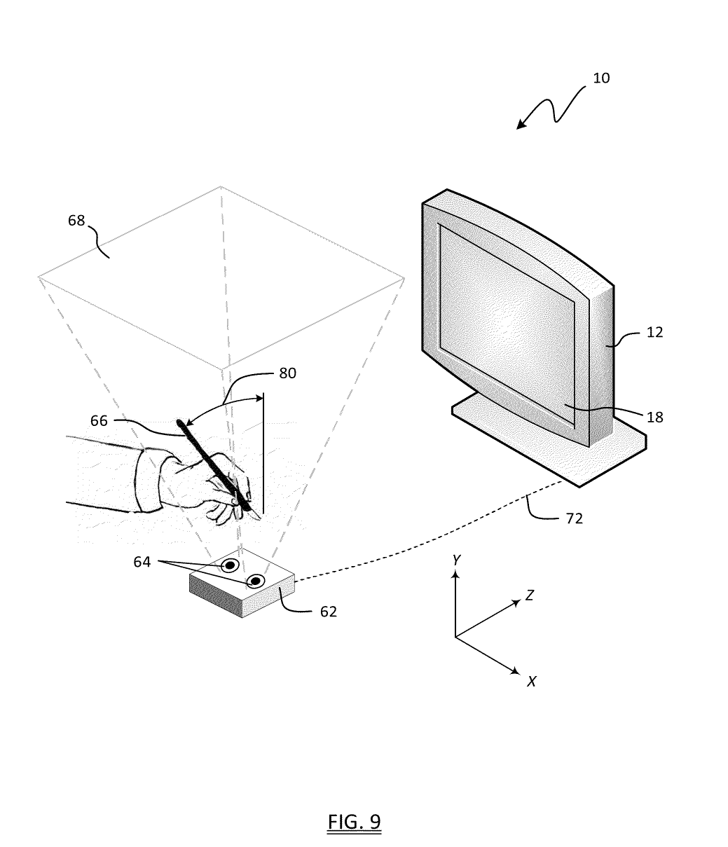

FIG. 8 depicts an enlarged view of the calibrated depth position 74 shown FIG. 7. The calibrated depth position 74 can include a center position Z₀, defining opposing zones Z₁ and Z₂. The zones can be configured to take different actions in the graphics application program. In one example, the depth value may be set to zero at center position Z₀, then increase as the tracking object moves towards the maximum (Z_{MAX}), and decrease as the object moves towards the minimum (Z_{MIN}). The scale of the zones can be different when moving the tracking object towards the maximum depth as opposed to moving the object towards the minimum depth. As illustrated, the depth distance through zone Z₁ is less than Z₂. Thus, a tracking object moving at roughly constant speed will pass through zone Z₁ in a shorter period of time, making an action related to the depth of the tracking object appear quicker to the user.

Furthermore, the scale of the zones can be non-linear. Thus, the mapping of the (z) coordinate data in the spatial coordinate data 72 is not a scalar, it may be mapped according to a quadratic equation, for example. This can be useful when it is desired that the rate of depth change accelerates as the distance increases from the central position.

Continuing with the example set forth above, wherein the tracking object 66 is a finger or a paint brush, and the graphics application program 60 may be a digital paint studio, the user may prepare to apply brush strokes to the virtual canvas by inserting the finger or brush into the visual space 68, at which time coordinate output data 72 begins streaming to the computer 12 for mapping, and the tracking object appears on the display 18. As the user approaches the virtual canvas 76, the tracking object passes into zone Z₁ and the object may be displayed on the screen. As the tracking object passes Z₀, which may signify the virtual canvas, a start brushstroke command is initiated and the finger or brush “touches” the virtual canvas and begins the painting or drawing stroke. When the user completes the brushstroke, the tracking object 66 can be moved in the z-axis towards the user, and upon passing Z₀ the stop brushstroke command is initiated and the tracking object “lifts” off the virtual canvas.

In another embodiment of the invention, the depth or position on the z-axis can be mapped to any of the brush's behaviors or characteristics. In one example, zone Z₂ can be configured to apply “pressure” on the tracking object 66 while painting or drawing. That is, once past Z₀, further movement of the tracking object into the second zone Z₂ can signify the pressure with which the brush is pressing against the canvas; light or heavy. Graphically, the pressure is realized on the virtual canvas by converting the darkness of the paint particles. A light pressure or small depth into zone Z₂ results in a light or faint brushstroke, and a heavy pressure or greater depth into zone Z₂ results in a dark brushstroke.

In some applications, the transformation from movement in the vision system to movement on the display is linear. That is, a one-to-one relationship exists wherein the amount the object is moving is the same amount of pixels that are displayed. However, certain aspects of the present invention can apply a filter of sorts to the output data to accelerate or decelerate the movements to make the user experience more comfortable.

In yet another embodiment of the invention, non-linear scaling can be utilized in mapping the z-axis to provide more realistic painting or drawing effects. For example, in zone Z₂, a non-linear coordinate transformation could result in the tracking object appearing to go to full pressure slowly, which is more realistic than linear pressure with depth. Conversely, in zone Z₁, a non-linear coordinate transformation could result in the tracking object appearing to lift off the virtual canvas very quickly. These non-linear mapping techniques could be applied to different lengths of zones Z₁ and Z₂ to heighten the effect. For example, zone Z₁ could occupy about one-third of the calibrated depth 74, and zone Z₂ could occupy the remaining two-thirds. The non-linear transformation would result in the zone Z₁ action appearing very quickly, and the zone Z₂ action appearing very slowly.

The benefit to using non-linear coordinate transformation is that the amount of movement in the z-axis can be controlled to make actions appear faster or slower. Thus, the action of a brush lifting up could be very quick, allowing the user to lift up only a small amount to start a new stroke.

In the illustrated embodiments, and FIG. 8 in particular, only two zones are disclosed. However, any number of zones having differing functions can be incorporated without departing from the scope of the invention. In this regard, the calibrated visual space 74 may include one or more control planes 78 to separate the functional zones. In FIG. 8, control plane Zₒ is denoted by numeral 78.

One feature that can be important to users of a graphics application program, such as a painting program, is the tilt and bearing angles of the particular tracking object or tool that is making the brush strokes. Tilt can be defined as how close to vertical the tool is held relative to the virtual surface. A tilt angle of 0° represents the tool being oriented vertically (e.g., straight up and down), while any positive tilt angle represents the degree to which the tool is tilted from the vertical. Bearing can be described as the compass direction in which the stylus is pointing. For any positive degree of tilt, the tool can “pointed” in any direction from 0° to 360°.

FIG. 9 depicts a perspective schematic view of a graphic computer software system 10 according to another embodiment of the present invention. A user's hand is illustrated holding a tracking object 66 in the visual space 68. The tracking object 66 can be a stylus, a pencil, or a finger, for example. In this embodiment, the tracking object 66 is a stylus detected by the vision system 62 and its spatial coordinate data 72 is input to a graphics application program 60 (FIG. 1) executing on the computer 12, for example a painting program. The manner in which the user's hand grips the tracking object 66 results in a corresponding value of tilt angle 80 and bearing angle 82 (shown in the top view of FIG. 7) for the tracking object 66. For example, the illustrated embodiment may have a tilt angle 80 of 30°, and a bearing angle 82 of 25°.

The disclosed graphics application program coupled with a vision system provides a more natural painting or drawing experience to artists. As may be appreciated, each user of the graphics application program may have an “at-rest” position of the user's hand in the visual space. The at-rest position can be described as that position that is most comfortable and natural for the particular user. Of course, the at-rest position will vary from user-to-user, depending upon such factors as right- or left-handedness, hand size, working surface, or the location of the hand relative to the visual space, for example. The at-rest position may change over time for a particular user, sometimes within the same graphics application program session, due to factors such as fatigue.

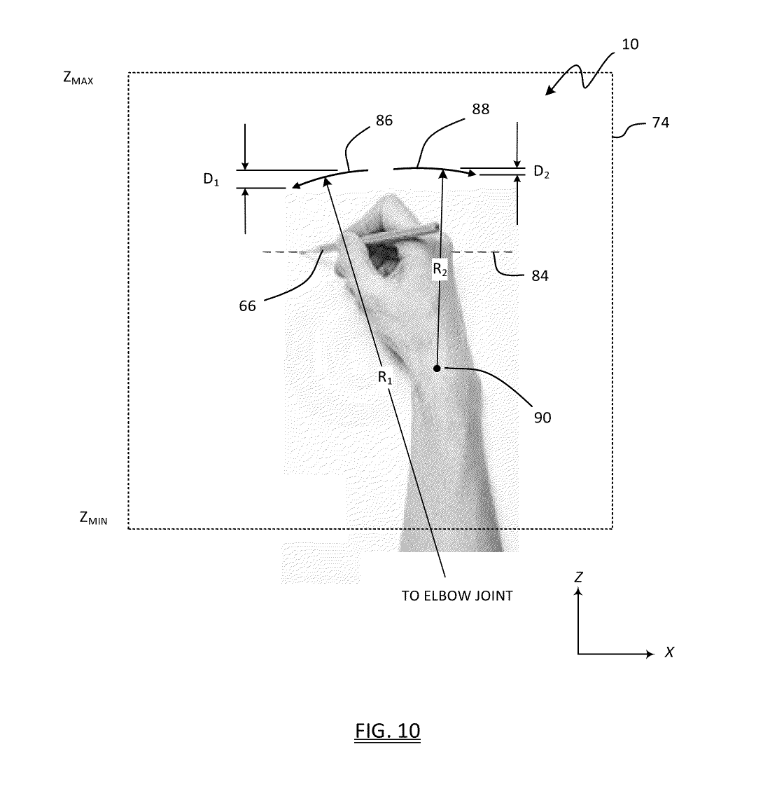

In addition to each user's unique “at-rest” position, the motion of the tracking object in the visual space, as guided by the user, will also be unique. Referring to FIG. 10, a top plan view of the graphic computer software system 10 of FIG. 9 is shown. The view illustrates a user in the process of drawing a straight line 84 in the calibrated visual space 74 of the vision system, and exemplifies one of the drawbacks associated with mapping coordinates from the tracking object 66. Note that the straight line 84 is merely a phantom line; the user is not actually setting a drawing implement to paper. One drawback associated with mapping coordinates is that the motion of every appendage in the human body makes an arc, because each joint is hinged. In FIG. 10, the motion of the user's arm actually pivots about at least two joints: the elbow and the wrist. Consequently, when the user moves their arm in the visual space 74, the arm moves about a first arc 86 having a radius R₁ approximately equal to the distance from the elbow joint (not shown) to the tip of the tracking object. The arm may also move about a shorter, second arc 88 having a radius R₂ approximately equal to the distance from the wrist joint 90 to the tip of the tracking object. To a lesser extent, the arm may also move about a third arc (not shown) having a radius approximately equal to the distance from the shoulder joint of the user to the tip of the tracking object. Thus, the motion of the arm forms a compound arc that may be difficult to predict or duplicate.

When the user attempts to draw a horizontal straight line 84 or other right-to-left linear motion in the visual space 74, the natural arcuate movement of the arm about the hinged joints of the user's body tends to displace the tracking object 66 in the depth axis (z-axis) so the line is not actually straight. For example, the first arc 86 may displace the tracking object 66 a distance D₁ in the z-direction, and the second arc 88 may displace the tracking object 66 a distance D₂ in the z-direction. As noted, the composite displacement in the z-direction is difficult to predict, particularly because the R₁ and R₂ values are different for every individual.

The displacement in the z-direction can affect any characteristic of the graphics application program 60 that is mapped to the depth portion of the spatial coordinate data 72. For example, if the user is performing a brush stroke, and the depth of the tracking object in the z-direction is mapped to the pressure of the brush on the paper, the resulting brush stroke could unintentionally vary in thickness across the horizontal axis, being thicker in the middle. The user may not understand this result, and even if they did, they may not be able to correct it.

Furthermore, the displacement values D₁ and D₂ may not be constant, but may vary in the vertical axis, due to the hinged motion of the user's arm. In one respect, the composite arc formed by all the joints may be approximately spherical within the visual space, having a maximum depth displacement at the center of the x- and y-axis, and a minimum displacement at the opposing corners of the visual space.

In one embodiment of the present invention, a calibration method is disclosed to compensate for the arcuate motion of the tracking object. In one example, a user may establish a calibrated set of “default” positions for the tracking object 66 within the visual space 68. By creating a set of positions representative of the user's most comfortable motions, the displacements in the z-direction caused by the arcuate motion can be compensated for, or factored out, when drawing on the virtual canvas. The graphics application program 60 may include a calibration routine that maps the position of the tracking object 66 in several locations of the visual space 68. In many circumstances, each position of the tracking object 66 at each calibration location will differ. The calibration utility may request that the user perform one or more ‘reaches’ to the extents of the visual space 68. As noted above, the user's arm pivots about the elbow and shoulder, and the hand pivots about the wrist, so the default positions established at the bottom of the visual space 68 may not remain at the same value as the user moves up in the y-axis and forward in the z-axis. The calibration utility may request the user ‘reach’ with the tracking object 66 from side to side, up to down, and corner to corner of the visual space 68. At each extent, a default position of the tracking object 66 can be captured by the image sensors 64 and calibration profiles 70 can be stored in the memory 48 of the computer 12. In one example, the calibration profile 70 may comprise a lookup table. In another example, the calibration profile 70 may fit an arc to the mapped positions. In addition, the calibration utility may request calibration profiles while a user is standing versus sitting, because natural human movement will create a different positions.

The computer 12 may include program instructions to interpolate an estimated arcuate position for locations between the calibrated positions to provide a smooth, three-dimensional transition. In this manner, the user can always expect the same result in relation to the drawing image, even though in reality the positions differ depending upon the user's location in the visual space 68. The calibration routine can account for the variations in the arcuate position in all three planes of the visual space 68 (e.g., x-y plane and z-plane).

In another implementation, the calibration utility may request that the user perform several practice strokes, such as a cross, a circle, or some other kind of standard motion that obtains the calibration points. In another implementation, the calibration utility may include a custom user-selectable sign-in that calibrates for the user.

In another embodiment of the invention, the calibrated arcuate positions in the visual space 68 can be mapped to account for user fatigue. That is, the graphics application program 60 may include a procedure that records the initial position of the tracking object 66 over time, and recalibrates the original position by making corrections to the x-, y-, and z-axis (or angular data) as the arcuate position changes. In this manner, as the user fatigues, they do not have to try and replicate their initial starting position.

In another embodiment of the invention, the user's calibrated default settings can be transferred from one computer system to another, such as from a desktop computer to a laptop. The graphics application program 60 can store the user settings for a first visual space, and scale them to a second visual space that may be at a different height and a different volume. In this manner, once a user established a comfortable at-rest position, there is no need to re-calibrate to a new computer system.

In operation, the calibration profile can compensate for the displacement of the tracking object at any point in the visual space due to the arcuate motion of the tracking object. Under normal circumstances, without calibration, the differences in the depth would be mapped to the particular characteristic in the graphics application program, such as brush stroke pressure, thereby causing variability. However, once calibrated, the graphics application program would recognize that at least a portion of the differences in the depth are attributable to the arcuate motion of the tracking object, and would compensate or remove those differences from the mapping function to the characteristic.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A method for calibrating a tracking object for use in a graphics application program executing on a computer, comprising the steps of:
connecting a vision system to a computer, the vision system adapted to monitor a visual space;
detecting, by the vision system, a tracking object in the visual space, the tracking object having an arcuate motion when guided by a user;
executing, by the computer, a graphics application program;
outputting, by the vision system to the computer, spatial coordinate data representative of the location of the tracking object within the visual space;
mapping a horizontal portion and a vertical portion of the spatial coordinate data to a display connected to the computer; and
calibrating the tracking object to compensate for the arcuate motion.

2. The method according to claim 1, wherein the arcuate motion displaces the tracking object a distance in a depth portion of the spatial coordinate data.

3. The method according to claim 2, wherein the displacement distance varies in the vertical portion of the spatial coordinate data.

4. The method according to claim 2, wherein the arcuate motion is a compound arc comprising a first arc displacing the tracking object a first distance in the depth direction, and a second arc displacing the tracking object a second distance in the depth direction.

5. The method according to claim 4, wherein the compound arc is approximately spherical.

6. The method according to claim 5, wherein the compound arc has a maximum depth displacement at the center of the horizontal and vertical axis, and a minimum displacement at opposing corners of the visual space.

7. The method according to claim 1, wherein the arcuate motion is the movement about a hinged joint of a user's body.

8. The method according to claim 7, wherein the hinged joint is the user's elbow joint.

9. The method according to claim 1, wherein the step of calibrating the tracking object comprises establishing a set of default positions for the tracking object within the visual space.

10. The method according to claim 9, further comprising mapping positions of the tracking object at the default positions.

11. The method according to claim 10, further including a step of calibrating the tracking object to compensate for user fatigue.

12. The method according to claim 11, including a step of recording an initial default position of the tracking object, and recalibrating the default position over time.

13. The method according to claim 10, further comprising the step of storing the mapped positions in a calibration profile in a memory location of the computer.

14. The method according to claim 13, wherein the calibration profile is a lookup table.

15. The method according to claim 13, wherein the calibration profile fits an arc to the mapped positions.

16. The method according to claim 9, further comprising the step of transferring the user's calibrated default settings from the computer to another computer.

17. The method according to claim 16, wherein the step of transferring the user's calibrated default settings comprises storing the user settings for a first visual space, and scaling them to a second visual space.

18. The method according to claim 17, wherein the second visual space is at a different height and/or a different volume.

19. The method according to claim 1, wherein the step of calibrating the tracking object comprises a step of a user performing one or more reaches to the extents of the visual space.

20. The method according to claim 1, wherein the step of calibrating the tracking object comprises a user reaching with the tracking object from side to side, up to down, or corner to corner of the visual space.

21. The method according to claim 1, wherein the step of calibrating the tracking object comprises a user performing one or more practice strokes.

22. The method according to claim 21, wherein the one or more practice strokes are circles.

23. A graphic computer software system, comprising:
a computer, comprising:
one or more processors;
one or more computer-readable memories;
one or more computer-readable tangible storage devices; and
program instructions stored on at least one of the one or more storage devices for execution by at least one of the one or more processors via at least one of the one or more memories;
a display connected to the computer;
a tracking object having an arcuate motion when guided by a user; and
a vision system connected to the computer, the vision system comprising one or more image sensors adapted to capture the location of the tracking object within a visual space, the vision system adapted to output to the computer spatial coordinate data representative of the location of the tracking object within the visual space;
the computer program instructions comprising:
program instructions to execute a graphics application program and output to the display; and
program instructions to calibrate the tracking object to compensate for the arcuate motion.
